(19) United States
(12) Patent Application Publication
(10) Pub. No.: US 2023/0102249 A1
(43) Pub. Date: Mar. 30, 2023

(54) POWER SIDE-CHANNEL ATTACK DETECTION THROUGH BATTERY IMPEDANCE MONITORING

(71) Applicant: The Board of Regents for the Oklahoma Agricultural and Mechanical Colleges, Stillwater, OK (US)

(72) Inventor: Anqiao Hu, Stillwater, OK (US)

(21) Appl. No.: 17/934,076

(22) Filed: Sep. 21, 2022

Related U.S. Application Data
(60) Provisional application No. 63/248,167, filed on Sep. 24, 2021.

(51) Int. Cl. G01R 31/389; G01R 31/36; G01R 31/367; G06F 21/75

(52) U.S. Cl. CPC G01R 31/389; G01R 31/3648; G01R 31/367; G06F 21/755

(57) ABSTRACT

A method is described including selecting an impedance threshold for a battery in electrical communication with an integrated circuit; acquiring an impedance of the battery; calculating an average impedance of the battery for a period of time; determining whether the integrated circuit is a victim of a power side channel attack if the average impedance of the battery for the period of time exceeds the impedance threshold; and responding to the power side channel attack.

### CROSS REFERENCE TO RELATED APPLICATIONS/INCORPORATION BY REFERENCE STATEMENT

This non-provisional application claims the benefit of U.S. Provisional Application No. 63/248,167, filed on Sep. 24, 2021. The entire contents of the above-referenced application are hereby expressly incorporated herein by reference in their entirety.

### BACKGROUND

The development of wireless communication technology and smart mobile devices enables users to access their mobile applications at any time. These applications include sharing personal information and financial transactions using credit cards. Therefore, securing personal and organizational data is an increasing demand. Many cryptographic algorithms have been developed to secure this sensitive information over a non-secure communication link. These algorithms are implemented in the hardware to meet the real-time requirements. In modern integrated circuits design, security against cyber-attacks is a significant concern. However, like software-based cybersecurity, secure hardware is also under attack. Adversaries have learned to break the cryptographic system (revealing the secret key) using channels such as heat, power consumption, time, and sound, which are not intended to leak sensitive information.

A side-channel attack (SCA) is a type of cyber-attack that targets a specific hardware implementation to reveal secret information instead of a software. The SCA is possible because hardware inevitably emits data-dependent, physically observable phenomenon during computing. These data-dependent, physically observable phenomenon, e.g., side channels, include power consumption and electromagnetic (EM) radiation, for example. Therefore, SCAs have become a significant threat to hardware security as the SCAs can be more difficult to detect than conventional algorithmic attacks.

Since the discovery of SCAs, various countermeasures have been proposed, including masking and hiding. Masking treats side-channel leakage as a mathematic problem and therefore seeks algorithm modifications to minimize leakage. Hiding, on the other hand, treats side-channel vulnerabilities as an engineering problem and applies logic, circuit, and system methods to reduce side-channel leakage's signal-to-noise ratio (SNR). However, neither approach can provide adequate security in practice because these approaches are fundamentally preventative measures that make secret revelation harder, not impossible. Furthermore, all the preventive countermeasures suffer from various limitations including performance degradation, high power consumption, low scalability, and area overhead (PPA Overhead), which are costly to a resource-constrained edge computing device.

One particular SCA is an electromagnetic side-channel attack (EM-SCA) and detection of EM-SCAB includes building an on-chip inductor coil to sense an approaching EM probe. At a close distance, the attacker's probe will form mutual inductance with the on-chip coil, which will cause a drop in the L value and a shift in the on-chip LC oscillator's frequency. Detection of an EM-SCA may include building a pair of co-planar capacitance to detect the EM probe, e.g., using two LC oscillators, a mixer, and a low pass amplifier to detect range and sensitivity. Use of an on-chip inductor coil to sense the approaching EM probe is only effective when the EM eavesdropping effect is “tangible.” That is, the approaching EM probe changes an \vec{E} field or \vec{H} field around the victim IC. Thus, an on-chip an \vec{E} field or \vec{H} field sensor will be able to detect EM-SCAB.

However, the on-chip inductor coil cannot be used to detect a power side-channel attack (P-SCA) because the power sensors used by an attacker in a P-SCA do not generate any change in the \vec{E} field or \vec{H} field surrounding the victim chip. Unlike an EM-SCA, where the attacker needs to be in proximation of the victim chip to measure electromagnetic radiation, a P-SCA can be launched remotely, e.g., without physical access to the device.

Prior art to detect a P-SCA assumes that the attacker would capture the victim's power traces through a small probe resistor connected between the external power supply and a power or ground (P/G) pin of the chip. The prior art proposed using machine learning to classify secure and compromised configurations after measuring the whole power distribution network (PDN) and the effect of the small prove resistor on the otherwise homogeneous on-chip power grid.

Other prior art assumes that the attacker would remove one of the package balls and insert a current sense resistor in its place to probe the current. Under this assumption, the P-SCA can be detected via the on-chip voltage differences the package modification introduced.

These prior-art methods, however, highlight the technical challenges in P-SCA detection: (1) a lack of “first-order” physical attribute that can serve as a clear indication of P-SCA, and (2) overly specific assumptions that do not fit many P-SCAs; thereby resulting in reliance on sensing “second-order” effects, such as PDN voltage variations requiring high computation, power, and hardware costs. Since the “second-order” effects can vary significantly with the attack model, detections have to make specific assumptions on the victim and location of P-SCAs.

Therefore, a need exists for a system and method of detecting a power side-channel attack using a first-order forensic to directly measure the attack surface that has a low computation, power, and hardware cost.

### SUMMARY

The problem of detecting a power side-channel attack using a first-order forensic to directly measure the attack surface that has a low computation, power, and hardware cost is solved by a computerized device comprising a battery having a battery impedance, an integrated circuit coupled to the battery; and an impedance monitoring system comprising at least one of a current detection system and a voltage detection system to monitor an impedance of the battery. The impedance monitoring system also includes a processor, and a non-transitory computer readable medium storing computer executable instructions that when executed by the processor, causes the processor to acquire an impedance of the battery; calculate an average impedance of the battery for a period of time; determine whether the integrated circuit is a victim of a power side channel attack if the average impedance of the battery for the period of time exceeds an impedance threshold; and respond to the power side channel attack.

The details of one or more implementations are set forth in the accompanying drawings and the description below. Other features and advantages will be apparent from the description and drawings, and from the claims.

### BRIEF DESCRIPTION OF SEVERAL VIEWS OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a diagram of an exemplary embodiment of a computerized device having an integrated circuit constructed in accordance with the present disclosure that is not a victim of a power side-channel attack.

FIG. 2 is a diagram of an exemplary embodiment of the computerized device of FIG. 1 having the integrated circuit constructed in accordance with the present disclosure that is a victim of a power side-channel attack

FIG. 3 is a diagram of an exemplary embodiment of the computerized device of FIG. 1 having a current detection system constructed in accordance with the present disclosure.

FIG. 4 is a diagram of an exemplary embodiment of the computerized device of FIG. 1 having an impedance monitoring system constructed in accordance with the present disclosure.

FIG. 5 is a process flow diagram of an exemplary embodiment of a P-SCA detection process in accordance with the present disclosure.

FIG. 6 is a diagram of an exemplary embodiment of a FIFO stack in accordance with the present disclosure.

### DETAILED DESCRIPTION

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted.

The disclosure is capable of other embodiments or of being practiced or carried out in various ways. For instance, although recommendations to promote collaboration between researchers may be used as an example, the methods and systems may be used to automatically assess and provide recommendations for other purposes, such as dating, or the like. Also, it is to be understood that the phraseology and terminology employed herein is for purposes of description, and should not be regarded as limiting.

As used in the description herein, the terms “comprises,” “comprising,” “includes,” “including,” “has,” “having,” or any other variations thereof, are intended to cover a non-exclusive inclusion. For example, unless otherwise noted, a process, method, article, or apparatus that comprises a list of elements is not necessarily limited to only those elements, but may also include other elements not expressly listed or inherent to such process, method, article, or apparatus.

Further, unless expressly stated to the contrary, “or” refers to an inclusive and not to an exclusive “or”. For example, a condition A or B is satisfied by one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more, and the singular also includes the plural unless it is obvious that it is meant otherwise. Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to computing tolerances, computing error, manufacturing tolerances, measurement error, wear and tear, stresses exerted on various parts, and combinations thereof, for example.

As used herein, any reference to “one embodiment,” “an embodiment,” “some embodiments,” “one example,” “for example,” or “an example” means that a particular element, feature, structure or characteristic described in connection with the embodiment is included in at least one embodiment and may be used in conjunction with other embodiments. The appearance of the phrase “in some embodiments” or “one example” in various places in the specification is not necessarily all referring to the same embodiment, for example.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

Circuitry, as used herein, may be analog and/or digital components, or one or more suitably programmed processors (e.g., microprocessors) and associated hardware and software, or hardwired logic. Also, “components” may perform one or more functions. The term “component,” may include hardware, such as a processor (e.g., microprocessor), an application specific integrated circuit (ASIC), field programmable gate array (FPGA), a combination of hardware and software, and/or the like. The term “processor” as used herein means a single processor or multiple processors working independently or together to collectively perform a task.

Software may include one or more computer readable instructions that when executed by one or more components cause the component to perform a specified function. It should be understood that the algorithms described herein may be stored on one or more non-transitory computer readable medium. Exemplary non-transitory computer readable mediums may include random access memory, read only memory, flash memory, and/or the like. Such non-transitory computer readable mediums may be electrically based, optically based, magnetically based, and/or the like.

Referring now to FIG. 1, shown therein is a diagram of an exemplary embodiment of a computerized device 8 having an integrated circuit 10 that is not a victim of a power side-channel attack. The integrated circuit 10 is connected to a battery 14. The battery 14 is shown to include only a battery impedance 18. The integrated circuit 10 may be circuitry of the computerized device 8 and may be connected to a network (not shown).

In one embodiment, the computerized device 8 is an internet of things (IoT) device. In other embodiments, the computerized device 8 can be other types of computerized electronic device powered by a battery, such as, a mobile phone (e.g., a smartphone), a tablet computer, a laptop computer, a smart watch, a digital still or video camera, a wearable health device, a portable audio device, and/or a portable gaming console, for example.

In one embodiment, the network is the Internet. It should be noted, however, that the network may be almost any type of network and may be implemented as the World Wide Web (or Internet), a local area network (LAN), a wide area network (WAN), a metropolitan network, a wireless network, a cellular network, a Global System for Mobile Communications (GSM) network, a code division multiple access (CDMA) network, a 3G network, a 4G network, a 5G network, a satellite network, a radio network, an optical network, a cable network, a public switched telephone network, an Ethernet network, combinations thereof, and/or the like. It is conceivable that in the near future, embodiments of the present disclosure may use more advanced networking topologies.

In one embodiment, the battery 14 is a single-cell or multiple-cell battery. In one embodiment, the battery 14 may include a rechargeable battery or a non-rechargeable battery. Additionally, the battery 14 may have a battery chemistry including Li-Ion, Li-Polymer, or any other battery chemistry type that has a resistance/impedance.

In one embodiment, the battery impedance 18 may have a known value, or expected value and may be determined based on a configuration of the battery 14, e.g., whether the battery is single-cell or multi-cell, whether the battery 14 is rechargeable, or the battery chemistry of the battery 14.

Further shown in FIG. 1 is a monitor node 22 disposed between the battery 14 and the integrated circuit 10. In one embodiment, an impedance of the battery 14 (R_{bat}) is determined by calculating the open-circuit voltage (OCV), or no-load voltage, of the battery 14 less the voltage at the monitor node 22 (V) divided by the current drawn by the integrated circuit 10 as illustrated by an Equation 1: R_{bat}=(OCV-V)/I. Calculating the impedance of the battery 14, R_{bat}, when it is known that the integrated circuit 10 is not compromised, e.g., by an SCA, results in an expected impedance of the battery 14. As discussed in more detail below, the processor 52 may store the expected impedance of the battery 14 in a memory 56.

The memory 56 is a non-transitory, computer readable medium operable to store computer-readable instructions that when executed by a processor cause the processor to perform a task, e.g., a process or a step of a process.

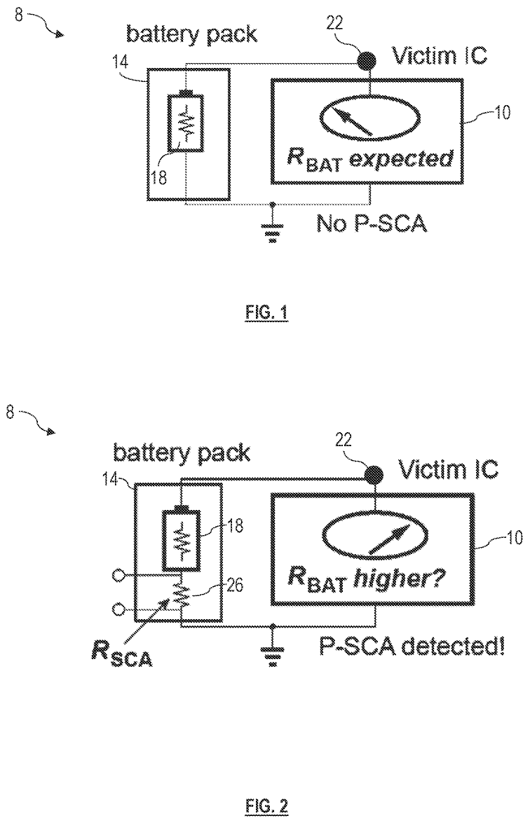

Referring now to FIG. 2, shown therein is a diagram of an exemplary embodiment of the computerized device 8 having the integrated circuit 10 of FIG. 1 that is a victim of a power side-channel attack. The integrated circuit 10 is connected to the battery 14. The battery 14 is shown to include the battery impedance 18 and a SCA impedance 26. The SCA impedance 26 is an additional impedance of the battery 14 caused by the power side-channel attack (P-SCA).

P-SCAs are known for their reliable and low-cost nature. Different techniques report sensitive power information from the integrated circuit 10. FIG. 2 illustrates a typical P-SCA setup. The SCA impedance 26 is connected between the battery 14 and the integrated circuit 10 or otherwise in-line with the battery 14. The SCA impedance 26 mirrors power information of the compromised node, e.g., at the monitor node 22, and reveals physical information of the integrated circuit 10. The SCA impedance 26 represents an intruder probing effect between the battery 14 and the integrated circuit 10.

Further shown in FIG. 2 is the monitor node 22 disposed between the battery 14 and the integrated circuit 10. In one embodiment, as discussed above, the impedance of the battery 14 (R_{bat}) is determined by calculating the open-circuit voltage (OCV), or no-load voltage, of the battery 14 less the voltage at the monitor node 22 (V) divided by the current drawn by the integrated circuit 10 as illustrated by the Equation 1: R_{bat}=(OCV-V)/I. Calculating the impedance of the battery 14, R_{bat}, i.e., by the processor, when it is unknown if the integrated circuit 10 is compromised, e.g., by an SCA, results in a detected impedance of the battery 14 that may be compared against the expected impedance of the battery 14 as determined above. As discussed in more detail below, the processor 52 may store the determined impedance of the battery 14 in a memory 56.

As shown in FIG. 2, because the battery 14 includes both the battery impedance 18 and the SCA impedance 26, the processor 52 when comparing the determined impedance to the expected impedance may determine that the integrated circuit 10 has been compromised by a P-SCA, for example, when the determined impedance is greater than the expected impedance, of FIG. 1. The following systems and methods are directed to detection, and subsequent handling of, the SCA impedance.

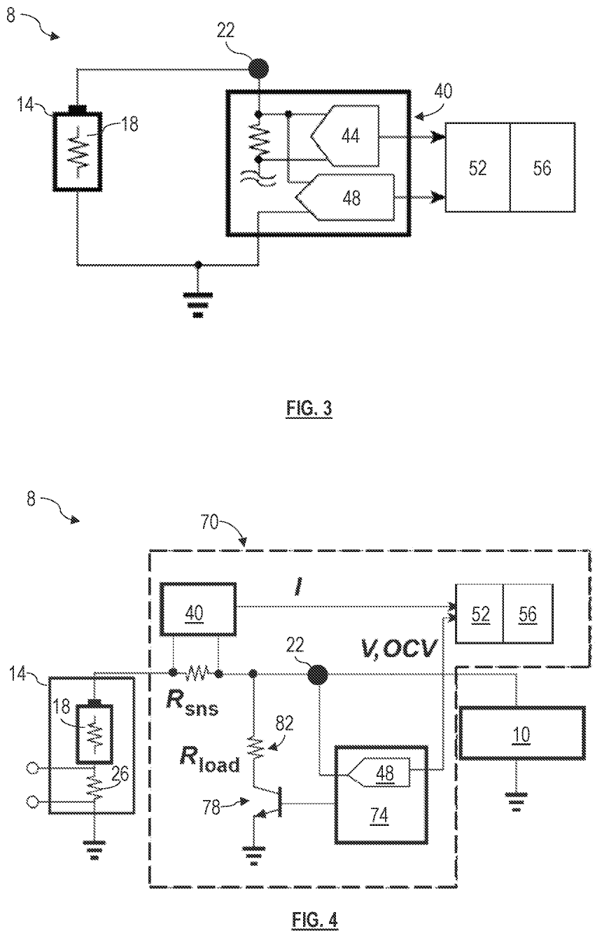

Referring now to FIG. 3, shown therein is an exemplary embodiment of the computerized device 8 having a current detection system 40 constructed in accordance with the present disclosure. The current detection system 40 may comprise a fuel gauge having a coulomb counter 44, an analog-digital converter, ADC 48, a processor 52, and a memory 56. In one embodiment, the ADC 48, the processor 52, and the memory 56 are integrated into the current detection system 40, e.g., are constructed as circuitry with the current detection system 40, whereas in other embodiments, the ADC 48, the processor 52, and the memory 56 are implemented separately from the current detection system 40.

The ADC 48 may have a precision indicated by a number of bits. In one embodiment, the ADC 48 is at least a 6-bit ADC. In other embodiments, the ADC 48 is an 8-bit ADC or a 10-bit ACD.

In one embodiment, the current detection system 40, comprising a fuel gauge, may include built-in impedance measurement capabilities. Examples of such fuel gauges includes the TI Impedance Track™ (Texas Instruments Incorporated, Dallas, Tex., USA) series of gas gauges, such as BQ27Z561, BQ40Z80, and BQ40Z50.

In one embodiment, the memory 56 stores program logic, for example, a set of instructions capable of being executed by one or more processor, i.e., the processor 52, that when executed by the processor 52 causes the processor 52 to carry out a series of actions.

In one embodiment, the processor 52 may periodically or continuously monitor an impedance of the battery 14. The impedance may be monitored by the processor 52 and stored in the memory 56. The current detection system 40 may also comprise a fuel gauge such as the MAX17201 which includes a real-time voltage (V) and current (I) reading which can be read by the processor 52 and used to calculate an impedance of the battery 14, such as by Equation 1: R_{bat}=(OCV-V)/I. In this manner, the current detection system 40 may determine the impedance of the battery 14.

Referring now to FIG. 4, shown therein is an exemplary embodiment of the computerized device 8 having an impedance monitoring system 70 constructed in accordance with the present disclosure. As shown, the impedance monitoring system 70 is disposed between the battery 14 and the integrated circuit 10. The impedance monitoring system 70 generally includes the current detection system 40, as discussed above, operable to determine the current I, and a voltage detection system 74.

The voltage detection system 74 generally includes the ADC 48 in communication with the processor 52. The ADC 48, disposed between the integrated circuit 10 and the battery 14, is operable to measure the open-circuit voltage (OCV), or no-load voltage, of the battery 14 and the voltage (V) at the monitor node 22. The voltage detection system 74 may also be in communication with and cause a transistor 78 to switch from an on state to an off state, such that the voltage detection system 74, by causing the transistor 78 to switch when the transistor 78 receives a base signal, may cause a load resistor 82 to be selectively applied as a resistance load on the battery 14. In one embodiment, the voltage detection system 74 causes the transistor 78 to selectively apply the load resistor 82 about every 8.70 ms rather than applying the load resistor 82 continuously to reduce power consumption from the battery 14. The base signal of the transistor 78 may be generated by the voltage detection system 74 as a pulse width modulation (PWM) signal, for example.

In one embodiment, the transistor 78 is an S8050 NPN transistor manufactured by Fairchild Semiconductor Corporation (Sunnyvale, Calif., USA). In other embodiments, the transistor 78 is any circuitry capable of selectively applying a load resistor 82 as a resistance load on the battery 14.

In one embodiment, as described in more detail above, the processor 52, by monitoring the ADC 48 may calculate the OCV and/or the voltage at the monitor node 22.

In one embodiment, the voltage detection system 74 includes, and is integrated with, one or more of the processor 52 and the memory 56, whereas in other embodiments, the voltage detection system 74 is separate from the processor 52 and the memory 56. In one embodiment, the voltage detection system 74 includes one or more of a processor and a memory separate from the processor 52 and the memory 56, and may communicate with the processor 52 or the memory 56 a value for the OCV and the voltage at the monitoring node 22. In one embodiment, the voltage detection system 74 may communicate unprocessed values from the ADC 48 whereas in other embodiments, the voltage detection system 74 may communicate processed values, such as a determined OVC or a V at the monitoring node 22, to the processor, such as the processor 52.

In one embodiment, the impedance monitoring system 70 is constructed as a single circuit disposed between the battery 14 and the integrated circuit 10. In other embodiments, one or more component of the impedance monitoring system 70 may be constructed separately and be communicatively coupled together to form the impedance monitoring system 70. In one embodiment, the processor 52 and the memory 56 may be implemented separately from other components of the impedance monitoring system 70 and may be remotely connected, e.g., through a network connection.

In one embodiment, the impedance monitoring system 70 is constructed as a single circuit disposed between the battery 14 and the integrated circuit 10 and the processor 52 may be in communication with a second processor (not shown) separate from the impedance monitoring system 70. In this embodiment, the processor 52 may transmit the current, the open circuit voltage, and the voltage at the monitoring node to the second processor. Alternatively, the processor 52 may transmit one or more signal to the second processor indicative of a P-SCA as determined by a P-SCA detection process 100.

An example of a single circuitry, having the hardware of the current detection system 40, the voltage detection system 74, the processor 52, and the memory 56 integrated into a single circuit, such as an integrated circuit includes the TI Impedance Track™ (Texas Instruments Incorporated, Dallas, Tex., USA) series of gas gauges, such as BQ27Z561, BQ40Z80, and BQ40Z50. It should be understood that the TI Impedance Track™ (Texas Instruments Incorporated, Dallas, Tex., USA) series of gas gauges, such as BQ27Z561, BQ40Z80, and BQ40Z50 does not include software, firmware (collectively instructions) for performing the P-SCA detection process 100.

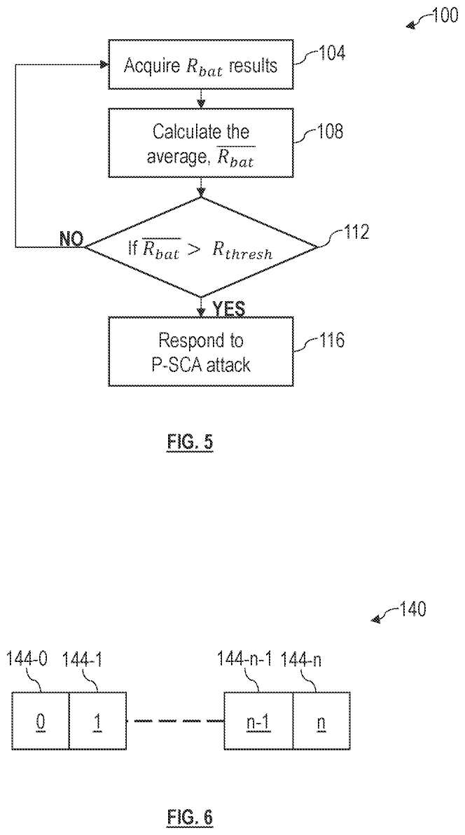

Referring now to FIG. 5, shown therein is a block diagram of the P-SCA detection process 100 in accordance with the present disclosure. The P-SCA detection process 100 generally includes the steps of: acquiring the battery impedance (step 104); calculating the average battery impedance (step 108); determining if the average battery impedance exceeds an impedance threshold (step 112); and responding to the P-SCA attack (step 116). The order of these steps is not considered critical and is exemplary in nature. Indeed, any suitable order of steps, including any intervening, preliminary, or subsequent optional steps can be included in the P-SCA detection process 100. In one embodiment, acquiring the battery impedance (step 104) may be performed repeatedly, or periodically, and simultaneously to one or more other step of the P-SCA detection process 100. In one embodiment, the P-SCA detection process 100 is implemented as software stored in the memory 56 that when executed by the processor 52 causes the processor 52 to perform one or more step of the P-SCA detection process 100 or other step or task as described below.

In one embodiment, acquiring the battery impedance (step 104) includes the processor 52 of the impedance monitoring system 70 receiving the OCV and voltage at the monitoring node 22 from the voltage detection system 74, receiving the current (I) from the current detection system 40, and calculating the impedance of the battery 14, such as by Equation 1: R_{bat}=(OCV-V)/I.

In one embodiment, acquiring the battery impedance (step 104) may further include storing, by the processor 52, the impedance of the battery 14 in the memory 56. The impedance of the battery 14 may be stored in a first-in-first-out (FIFO) stack in the memory 56, as shown below in FIG. 6. The FIFO stack may have a predetermined number of indexes and is shown in FIG. 6 as having ten (10) indexes. After each index of the FIFO stack has be filled with a measurement of the impedance of the battery 14, any additional measurement stored in the FIFO stack may cause the FIFO stack to drop, or remove, the oldest measurement in the FIFO stack. In this manner, the FIFO stack contains only the n newest measurement of the impedance of the battery 14 where n is the number of indexes of the FIFO stack.

In one embodiment, it may take at least 12 us to shift each measurement in the FIFIO stack to receive a new measurement. The amount of time required to shift each measurement may be dependent on the hardware used in constructing the impedance monitoring system 70. For example, the amount of time required to shift each measurement may be dependent on a speed one or more component of the impedance monitoring system 70, such as the of the processor 52, the memory 56, the voltage detection system 74, the current detection system 40, and/or a communication speed between each of the aforementioned components, for example.

In one embodiment, acquiring the battery impedance (step 104) may be performed periodically, e.g., at least once every period of time. In one embodiment, the period of time is 22 ms. In some embodiments, acquiring the battery impedance (step 104) may be performed in a shorter amount of time. The amount of time required to acquire the battery impedance (step 104) may be dependent on a speed one or more component of the impedance monitoring system 70, such as the of the processor 52, the memory 56, the voltage detection system 74, the current detection system 40, and/or a communication speed between each of the aforementioned components, for example.

In one embodiment, acquiring the battery impedance (step 104) includes transmitting, by a first processor, the OCV and the voltage at the monitoring node 22 determined by the voltage detection system 74, and transmitting, by the first processor, the current (I) determined by the current detection system 40 to the processor 52, e.g., via the network, where the processor 52 and the memory 56 are separate from the current detection system 40 and the voltage detection system 74.

In one embodiment, calculating the average battery impedance (step 108) includes implementing a moving window average filter by summing the measurements at each index of the FIFO stack and dividing by the number of indexes of the FIFO stack. In one embodiment, calculating the average battery impedance (step 108) may include averaging the measurements in the FIFO stack by taking a weighted average, for example, where newly added measurements are weighted more than older measurements, or where older measurements are weighted more than newly added measurements.

In one embodiment, calculating the average battery impedance (step 108) may be performed within 4 us. The amount of time required to calculate the average battery impedance may be dependent on the hardware used in constructing the impedance monitoring system 70. For example, the amount of time required to calculate the average battery impedance may be dependent on a speed one or more component of the impedance monitoring system 70, such as the of the processor 52, the memory 56, the voltage detection system 74, the current detection system 40, and/or a communication speed between each of the aforementioned components, for example.

In one embodiment, calculating the average battery impedance (step 108) may include calculating a sum of the measurements in the FIFO stack and a new measurement (e.g., before the new measurement has been added to the FIFO stack) and dividing by one more than the number of indices of the FIFO stack. In this manner, the moving window average filter may include one measurement more than the size of the FIFO stack.

In one embodiment, calculating the average battery impedance (step 108) may include calculating the average battery impedance by the processor 52 where the processor 52 and the memory 56 are separate from the current detection system 40 and the voltage detection system 74, e.g., via the network.

In one embodiment, determining if the average battery impedance exceeds an impedance threshold (step 112) includes comparing the average battery impedance to the expected impedance of the battery 14 discussed above. If the average battery impedance is greater than the expected impedance of the battery 14, the P-SCA detection process 100 continues on to responding to the P-SCA attack (step 116), otherwise the P-SCA detection process 100 continues back to acquiring the battery impedance (step 104).

In one embodiment, determining if the average battery impedance exceeds an impedance threshold (step 112) includes, once each index of the FIFO stack has a measurement, setting the impedance threshold at a percentage above the average battery impedance. Then, as additional measurements are provided to the FIFO stack, the average battery impedance is compared to the impedance threshold. If the average battery impedance is greater than the impedance threshold, the P-SCA detection process 100 continues on to responding to the P-SCA attack (step 116), otherwise the P-SCA detection process 100 continues back to acquiring the battery impedance (step 104).

In one embodiment, the percentage above the average battery impedance is 7%, whereas in other embodiments, the percentage above the average battery impedance is selected by a user. The user may increase the percentage above the average battery impedance to account for a broader variation in the impedance of the battery 14 or may lower the percentage above the average battery impedance to trigger a P-SCA attack detection for smaller pr lesser variances in the impedance of the battery 14. However, decreasing the percentage above the average battery impedance may result in false P-SCA attack detection whereas increasing the percentage above the average battery impedance may result in a failure of P-SCA attack detection. The balance between false P-SCA attack detection and a failure of P-SCA attack detection may be determined by the user and implemented as the percentage above the average battery impedance.

In one embodiment, determining if the average battery impedance exceeds an impedance threshold (step 112) may take 4 us. The amount of time required to determine if the average battery impedance exceeds the impedance threshold may be dependent on the hardware used in constructing the impedance monitoring system 70. For example, the amount of time required to determine if the average battery impedance exceeds the impedance threshold may be dependent on a speed one or more component of the impedance monitoring system 70, such as the of the processor 52, the memory 56, the voltage detection system 74, the current detection system 40, and/or a communication speed between each of the aforementioned components, for example.

In one embodiment, responding to the P-SCA attack (step 116) includes alerting the user of the P-SCA. Alerting the user may include any auditory, haptic, or visual feedback to alert the user of the P-SCA. Alerting the user may also include sending a notification to the user, such as a digital notification.

In one embodiment, responding to the P-SCA attack (step 116) includes halting the operation of the integrated circuit 10. Halting the operation of the integrated circuit 10 may include the processor 52 sending a signal to the integrated circuit 10 causing the integrated circuit 10 to halt operations.

In one embodiment, responding to the P-SCA attack (step 116) includes both alerting the user of the P-SCA and halting the operation of the integrated circuit 10 as described above.

In one embodiment, responding to the P-SCA attack (step 116) may include receiving by the impedance monitoring system 70, from the processor 52, a signal indicative of a P-SCA and responding by one or more of alerting the user of the P-SCA and halting the operation of the integrated circuit 10 as described above.

In one embodiment, responding to the P-SCA attack (step 116) includes sending a signal indicative of detection of the P-SCA to a second processor separate from the processor 52. For example, the processor 52 may transmit the signal indicative of the P-SCA to the second processor where the second processor is associated with, or integrated into, the integrated circuitry 10.

In one embodiment, the P-SCA detection process 100 may take about 220 ms to initialize by filling the FIFO stack with measurements as discussed above. After initialization, the P-SCA detection process 100 may detect a P-SCA within 22.020 ms of initialization of the P-SCA. In this way, the P-SCA detection process 100 is 590.4 times faster than the attack time (key detection time) of about 13 seconds.

In one embodiment, selection of each of the components of the impedance monitoring system 70 may include selecting each component such that the speed of each component of the impedance monitoring system 70, such as the of the processor 52, the memory 56, the voltage detection system 74, the current detection system 40, and/or the communication speed between each of the aforementioned components is able to perform the P-SCA detection process 100 before an attacker is able to probe the integrated circuit 10 to reveal a key. For example, if an attacker is able to probe the integrated circuit 10 to reveal the key in 1000 ms, each component of the impedance monitoring system 70 should be selected such that the impedance monitoring system 70 can perform the P-SCA detection process 100 in less than 1000 ms.

Referring now to FIG. 6, shown therein is a FIFO stack 140 in accordance with the present disclosure. The FIFO stack 140 includes a plurality of indexes 144 from 0 to n. The FIFO stack 140, having an n number of indices, receives a first measurement into index 144-n. When the FIFO stack 140 receives a second measurement, the first measurement may be moved from index 144-n to index 144-n-1 and the second measurement may be inserted into index 144-n. In this way, as the FIFO stack 140 receives additional measurements, the measurements in each index 144 are moved to the next lower index until each index 144 of the FIFO stack 140 includes a measurement. Once the FIFO stack 140 has a measurement for each index and the FIFO stack 140 receives a third measurement, the first measurement in index 144-0 is removed from the FIFO stack 140, each measurement in the FIFO stack 140 is moved to the next-lower index, such that, for example, the second measurement is in the index 144-0, and the third measurement is inserted into index 144-n. In one embodiment, averaging the FIFO stack 140 includes averaging the measurement in each index 144, e.g., averaging the measurements in index 144-0 to index 144-n.

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred embodiment. Further, the phrase “based on” is intended to mean “based, at least in part, on” unless explicitly stated otherwise.

From the above description and examples, it is clear that the inventive concepts disclosed and claimed herein are well adapted to attain the advantages mentioned herein. While exemplary embodiments of the inventive concepts have been described for purposes of this disclosure, it will be understood that numerous changes may be made which will readily suggest themselves to those skilled in the art and which are accomplished within the spirit of the inventive concepts disclosed and claimed herein.

What is claimed is:

1. A method, comprising:
selecting an impedance threshold for a battery in electrical communication with an integrated circuit;
acquiring an impedance of the battery;
calculating an average impedance of the battery for a period of time;
determining whether the integrated circuit is a victim of a power side channel attack if the average impedance of the battery for the period of time exceeds the impedance threshold; and
responding to the power side channel attack.

2. The method of claim 1, wherein responding to the power side channel attack further includes notifying the user of the power side channel attack via one or more of an auditory feedback, a haptic feedback, or a visual feedback.

3. The method of claim 1, wherein responding to the power side channel attack further includes halting operation of the integrated circuit.

4. The method of claim 1, wherein acquiring the impedance of the battery includes:
acquiring an open channel voltage, a voltage at the monitoring node, and a current; and
calculating the impedance of the battery using the open channel voltage, the voltage at the monitoring node, and the current.

5. The method of claim 4, wherein acquiring the current includes determining the current using a fuel-gauge having a coulomb counter.

6. The method of claim 1, wherein acquiring the impedance of the battery is performed more than once and each performance of acquiring the impedance of the battery is separated from a prior performance of acquiring the impedance of the battery by a second period of time.

7. The method of claim 6, wherein the second period of time is about 22 ms.

8. The method of claim 1, wherein acquiring the impedance of the battery further includes storing, by a processor, the impedance of the battery in a first-in, first-out (FIFO) stack in a memory.

9. The method of claim 8, wherein calculating the average impedance of the battery for the period of time includes averaging each impedance of the battery stored in the FIFO stack.

10. The method of claim 8, wherein acquiring the impedance of the battery further includes storing, by the processor, at least a previous ten (10) impedances of the battery in the FIFO stack in the memory.

11. A computerized device comprising:
a battery having a battery impedance;
an integrated circuit coupled to the battery; and
an impedance monitoring system comprising at least one of a current detection system and a voltage detection system to monitor an impedance of the battery, a processor, and a non-transitory computer readable medium storing computer executable instructions that when executed by the processor, causes the processor to
acquire an impedance of the battery;
calculate an average impedance of the battery for a period of time;
determine whether the integrated circuit is a victim of a power side channel attack if the average impedance of the battery for the period of time exceeds an impedance threshold; and
respond to the power side channel attack.

12. The computerized device of claim 11, wherein the current detection system comprises a fuel-gauge having a coulomb counter.

13. The computerized device of claim 11, wherein the voltage detection system comprises an analog to digital converter operable to determine an open channel voltage and a voltage of a monitoring node.

14. The computerized device of claim 11, wherein the non-transitory computer readable medium further stores computer executable instructions that when executed by the processor causes the processor to respond to the power side-channel attack by one or more of notifying the user of the power side channel attack via one or more of an auditory feedback, a haptic feedback, or a visual feedback or halting operation of the integrated circuit.

15. The computerized device of claim 11, wherein the impedance threshold is determined by a user or is determined by the processor by setting the impedance threshold to value above the average impedance of the battery by a threshold percentage.

16. The computerized device of claim 15, wherein the threshold percentage is 7%.

17. An impedance monitoring system comprising:
a current detection system having a fuel gauge and operable to detect a current from a battery to an integrated circuit;
a voltage detection system having an analog to digital converter and a transistor operable to selectively apply a load resistor to a battery, the voltage detection system operable to detect an open circuit voltage and a voltage at a monitoring node;
a first processor; and
a non-transitory computer readable medium storing computer executable instructions that when executed by the first processor, causes the first processor to:
transmit at least one of the current, the open circuit voltage and the voltage at the monitoring node to a second processor separate from the first processor;
receive a signal indicative of a power side channel attack; and
respond to the power side channel attack.

18. The impedance monitoring system of claim 17, wherein the non-transitory computer readable medium further stores computer executable instructions that when executed by the processor causes the processor to respond to the power side-channel attack by one or more of notifying the user of the power side channel attack via one or more of an auditory feedback, a haptic feedback, or a visual feedback, or halting operation of an integrated circuit.

19. The impedance monitoring system of claim 17, wherein the voltage detection system detects the voltage at the monitoring node by selectively applying the load resistor by supplying a base signal to the transistor.

20. The impedance monitoring system of claim 17, wherein analog to digital converter is at least a 6-bit analog to digital converter.
